(19) United States
(12) Patent Application Publication
(10) Pub. No.: US 2025/0339769 A1
(43) Pub. Date: Nov. 6, 2025

(54) GAMIFIED VIRTUAL CONSTRUCTION LAB

(71) Applicant: The Texas A&M University System, College Station, TX (US)

(72) Inventors: Manish Kumar Dixit, College Station, TX (US); Wei Yan, College Station, TX (US); Hassan Taye Anifowose, College Station, TX (US)

(73) Assignee: The Texas A&M University System, College Station, TX (US)

(21) Appl. No.: 19/197,358

(22) Filed: May 2, 2025

Related U.S. Application Data
(60) Provisional application No. 63/642,176, filed on May 3, 2024.

(51) Int. Cl. A63F 13/46; A63F 13/525; A63F 13/577

(52) U.S. Cl. CPC A63F 13/46; A63F 13/525; A63F 13/577

(57) ABSTRACT

A system for providing a gamified virtual construction lab, comprising a game model system generating a virtual game environment, an objectives system displaying one or more game objectives to a user in the virtual game environment, a user movement system receiving object selection data by a user of an object in the virtual environment, user movement data from one or more movement data sources, and object orientation data from one or more user orientation data sources, to determine whether the user movement data and the user orientation data results in a collision between the selected object and the virtual game environment and to generate collision data, and a scoring system receiving the collision data and the game objectives and generating score data in response.

### RELATED APPLICATIONS

The present application claims benefit of and priority to U.S. Provisional Patent Application No. 63/642,176, filed May 3, 2024, which is hereby incorporated by reference for all purposes as if set forth herein in its entirety.

### TECHNICAL FIELD

The present disclosure relates generally to training systems, and more specifically to a gamified virtual construction lab that provides a virtual reality, augmented reality and mixed reality training experience.

### BACKGROUND OF THE INVENTION

Construction and other industrial and commercial

activities can be hazardous. It is difficult to train for such activities without creating hazardous situations.

### SUMMARY OF THE INVENTION

A system for providing a gamified virtual construction lab, comprising a game model system generating a virtual game environment, an objectives system displaying one or more game objectives to a user in the virtual game environment, a user movement system receiving object selection data by a user of an object in the virtual environment, user movement data from one or more movement data sources, and object orientation data from one or more user orientation data sources, to determine whether the user movement data and the user orientation data results in a collision between the selected object and the virtual game environment and to generate collision data, and a scoring system receiving the collision data and the game objectives and generating score data in response.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of an algorithm for setting a timer in a gamified virtual construction lab, in accordance with an example embodiment of the present disclosure;

FIG. 2 is a diagram of an algorithm for setting a score in a gamified virtual construction lab, in accordance with an example embodiment of the present disclosure;

FIG. 3 is a diagram of an algorithm for creating level manager scripts in a gamified virtual construction lab, in accordance with an example embodiment of the present disclosure; and

FIG. 4 is a diagram of an algorithm for controlling user interaction in a gamified virtual construction lab, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

The present application claims benefit of and priority to U.S. Provisional Patent Application No. 63/642,176, filed May 3, 2024, which is hereby incorporated by reference for all purposes as if set forth herein in its entirety.

The present disclosure relates to a virtual reality/augmented reality/mixed reality construction lab and includes systems and methods for gamified learning in a virtual or quasi-virtual environment. Because augmented reality and mixed reality systems include a virtual component that is generated in an optical head-mounted display, a virtual reality headset or other suitable devices, those systems are referred to herein as VR or virtual reality. However, movement in the VR or virtual reality environment will typically involve actual physical movement of a user in an empty physical environment, to eliminate the risk of a collision with a real object. In an alternate embodiment, the physical environment can include one or more physical objects, where such physical objects are used to provide a more realistic training environment. Other suitable devices such as tablet computers, smart telephones or the like can also or alternatively be used.

The present disclosure provides a VR construction lab that creates an immersive and interactive platform for users to learn and practice construction assembly-related tasks in a controlled virtual environment. It can be customized to meet industry-specific assembly training needs. This adaptability ensures that the application can cater to various scenarios, making it a versatile tool for different vocational training and educational purposes.

Example tasks that can be modelled include but are not limited to:
1) moving a large wall panel that restricts/obstructs the user's field of vision through an area that include physical and structural components that need to be avoided, such as by modeling how the wall panel is being held by the user and the orientation of the user in the virtual environment;
2) moving a small object that does not obstruct the user's field of vision such as an aluminum track or other object through an area that include physical and structural components that need to be avoided, such as by modeling how the aluminum track or other object is being held by the user and the orientation of the user in the virtual environment;
3) assembling a temporary structure such as wall panels that restrict/obstruct the user's field of vision in an area that include physical and structural components that need to be avoided, such as by modeling how the wall panels are being held by the user, where the wall panels are located when they are released and the orientation of the user in the virtual environment;
4) moving a complex object such as a ladder through an area that include physical and structural components that need to be avoided, such as by modeling how the ladder is being held by the user and the orientation of the user in the virtual environment;
5) setting up a complex object such as a ladder in an area that include physical and structural components that need to be avoided;
6) using a complex object such as a ladder that has weight and balance constraints that require load coordination;
7) assembling a plurality of similar or dissimilar objects into a predetermined structure, such as by modeling how the objects are oriented within the virtual environment or how they are being held by the user and the orientation of the user in the virtual environment;
8) stacking materials such as boxes on a pallet, such as by modeling how the boxes are being held by the user and the orientation of the user, the boxes and the pallet in the virtual environment;
9) installing a prefabricated window unit into a wall, such as by modeling how the prefabricated window is being held by the user, the orientation of the user in the virtual environment and where the prefabricated window is placed in the virtual environment;
10) installing a prefabricated door assembly into a wall, such as by modeling how the prefabricated door assembly is being held by the user, the orientation of the user in the virtual environment and where the prefabricated door assembly is placed in the virtual environment;
11) running a cable through a conduit, such as by modeling how the cable is being held by the user, the orientation of the user in the virtual environment and where the cable is placed in the virtual environment;
12) installing electrical raceway on a support structure, such as by modeling how the electrical raceway is being held by the user, the orientation of the user in the virtual environment and where the electrical raceway is placed in the virtual environment;
13) installing a component into a motor control center, such as by modeling how the component is being held by the user, the orientation of the user in the virtual environment and where the component is placed in the virtual environment;
14) installing a component into the correct location in a panel, such as by modeling how the component is being held by the user, the orientation of the user in the virtual environment and where the component is placed in the virtual environment;
15) connecting electrical, water or drainage facilities to a component, such as by modeling how the component is being held by the user, the orientation of the user in the virtual environment and where the component is placed in the virtual environment;
16) identifying potential hazards and taking appropriate action to mitigate the hazard; and
17) identifying incorrectly installed components or other errors and taking appropriate action to correct the error.

The present disclosure addresses industry problems related to high training costs, material waste and safety concerns inherent in traditional training approaches. By offering a virtual alternative to traditional training methods, the VR construction lab can significantly enhance a user training experience to reduce training costs while providing enhanced safety awareness.

The VR construction lab of the present disclosure can simulate construction assembly tasks in a virtual environment, offering users a hands-on experience to enhance their skills and confidence for real-world construction tasks, allowing users to gain practical skills in a risk-free setting. The VR construction lab includes a number of components and systems (also called modules) that are used to create a dynamic and realistic virtual environment that mimics real world environments in scale, and which creates simulated visual and audio cues that can prepare a user for actual visual and audio experiences. The present disclosure uses strategically developed and tested sequences and combinations of these components to make the VR construction lab gamified learning technology unique. The following modules in a game model system provide an example embodiment of the present disclosure.

An object scale and photorealism module (or object model system) can be implemented as one or more algorithms that are loaded into a working memory of a processor that cause the processor when executed to provide a virtual environment that contains realistic size/scale of construction components to a user that are derived from scanned textures of real-world objects. The components can be implemented as objects in a virtual environment that have features that replicate actual components. For example, the components can include tools such as a ladder, a hammer, a forklift, a power lift, scaffolding, power tools and other suitable tools. The components can also include structural components such as windows, doors, blocks, beams, wet concrete mix and other suitable structural components. The components can also include treatments such as paint, welding, caulk, a vacuum, an air hose or other suitable treatments.

A collision detection system and listener module can be implemented as one or more algorithms that are loaded into a working memory of a processor that cause the processor when executed to determine the outcome of the game logic by processing data that defines a user's actions. The collision detection system determines when the user is ready to commence the activities after practicing or observing game components in the environment. In one example embodiment, a collision can be modelled based on how an object is being carried in a virtual environment as a function of the orientation of the user (where they are holding the object, how they are holding the object and so forth), such as to detect when the object has impacted a structural component, another object and so forth. Collision detection can also be used to detect whether an intentional collision or contact has been achieved, such as placement of an object in a specific location, balance of stacked objects to model whether excessive weight would cause an object like a ladder to fall over or become damaged and so forth.

Game logic can be implemented as one or more algorithms that are loaded into a working memory of a processor that cause the processor when executed to provide timing, scoring, and level management to determine player advancement or retrogression. The game logic can be implemented as the following three modules, which can be dependent on one another and can be triggered based on code line items used in establishing their relationships.

A timer module can be implemented as one or more algorithms that are loaded into a working memory of a processor that cause the processor when executed to detect when the player is ready, such as when automatically triggered by the first detected correct collision with the assembly or in other suitable manners. The timer module can generate a user display in the virtual environment to provide feedback to the user, such as how long they have been performing a task or other suitable feedback. In one example embodiment, a user can be instructed to move wall panels in the virtual environment, where the panel restricts/obstructs the user's view of the virtual environment. If the user collided with a structural component while moving the wall panel in a real environment, the wall panel could be damaged, the structural component could be damaged, the user could be injured or other adverse conditions could be created by the user's interaction with the virtual environment. A user might thus try to compensate for such problems by stopping, setting the panel down and taking other actions that would delay the task. By including a timer as part of the scoring component, the user can be trained to improve their function with decreasing time intervals.

A scoring module can be implemented as one or more algorithms that are loaded into a working memory of a processor that cause the processor when executed to determine when a task has been properly completed, that read and record scores, and that generate user interface displays to inform the user of progress. In one example embodiment, a score can include {current score/total score}, such as “6/12” where 6 is the number of tasks completed correctly and 12 is the total number of tasks available in each level.

A level management module can be implemented as one or more algorithms that are loaded into a working memory of a processor that cause the processor when executed to determine whether a user should progress to a new level, based on the task completions in a current level. Unlike a game environment where a level might be completed upon successfully handling a single task, the learning experience of the present disclosure can be completed after a player has successfully handled all tasks in all levels. A game state monitoring and feedback module can be

implemented as one or more algorithms that are loaded into a working memory of a processor that cause the processor when executed to monitor a user's behavior and determine what to report or feedback to the user. In one example embodiment, correct steps can be recorded using the scoring module, wrong steps can be recorded using the scoring module, and impossible steps can be recorded by the collision detection system to provide audio and haptic feedback to the user, such as via a vibration signal or in other suitable manners. The orientation of the user can be monitored and used to change the location and orientation of an object that the user is holding, such as to reflect how the user is holding the object, where the user's hands are located on the object, where the user's hands are located in the virtual environment and so forth.

A help system module can be implemented as one or more algorithms that are loaded into a working memory of a processor that cause the processor when executed to allow users to seek help via an embedded video tutorial with actions that can be mimicked, reducing the need to depend on instructors.

A progressing level of difficulty module can be implemented as one or more algorithms that are loaded into a working memory of a processor that cause the processor when executed to develop geometric associations as a function of an increasing complexity of assembly, starting with miniature assembles to full body size assemblies with consistent similarities in required player action or flow. The level of difficulty module can also determine whether a task replica should be shown to the player, such as an animated VR sequence that allows the user to see a task from their current VR perspective and using any real-world objects that are part of the task. When player scoring data indicates that a predetermined level of competency has been reached, the display of replicas can be modified, such as to only show ghost outlines, or eliminated, including elimination of ghost outlines, thereby providing a more accurate simulation of real-world scenarios.

A level management module can be implemented as one or more algorithms that are loaded into a working memory of a processor that cause the processor when executed to receive data that defines the user's behavior, such as image data, haptic data, movement sensor data or other suitable data. The data can be updated at a suitable interval, such as 75 times per second, and analyzed at each update to determine a next action for the user or the system. Levels can be unlocked based on completion scores, to allow the user to progress through the game as they improve their real-world construction activity skills.

A developer generosity module can be implemented as one or more algorithms that are loaded into a working memory of a processor that cause the processor when executed to reduce allowances and tolerances for the players to reinforce learning. This module allows players to develop confidence and depend less on the help system to avoid making mistakes, so that they can attempt to correct problems or mistakes themselves and without any allowances or tolerances. Developer generosity is reduced or eliminated in higher game levels.

A reward module can be implemented as one or more algorithms that are loaded into a working memory of a processor that cause the processor when executed to generate a combination of visual and audio feedback rewards to a user for each correctly completed task and surpassed level. In one example embodiment, a ‘positive’ audio chime sound can be generated and a simultaneous ghost outline can be eliminated for every correctly placed object in the game, to indicate progress. A dynamic visual particle system can also be generated on the user's heads-up display (HUD) using a yellow hue which is detectable by color-blind users. The user's senses can be tuned towards completing the challenges, therefore reducing frustration and increasing engagement and the willingness to complete the game.

Different metrics in the VR construction lab contribute to learning. A level of progression or difficulty metric can be used to show the contribution to learning, such as by increasing difficulty, timer, scoring, and reward systems towards unlocking new levels. These functions contribute the most to player knowledge of construction assembly-related tasks. Skill reinforcement and performance are improved in users who complete the simpler game levels of difficulty compared to those who attempt the highest game level outright.

The several components of the game include but are not limited to timer integration, scoring, and level management. The timer system in the game can be based on different game logics to achieve the same objective, which is, beginning a clock counter that will count towards player performance. In one example embodiment, two logics for timing can be provided, such as one that is initiated by collision detection, where the timer automatically starts if a scored object is inserted into a slot, and a second that is initiated by a player action, such as when a player chooses to start the timer when ready to begin the assembly.

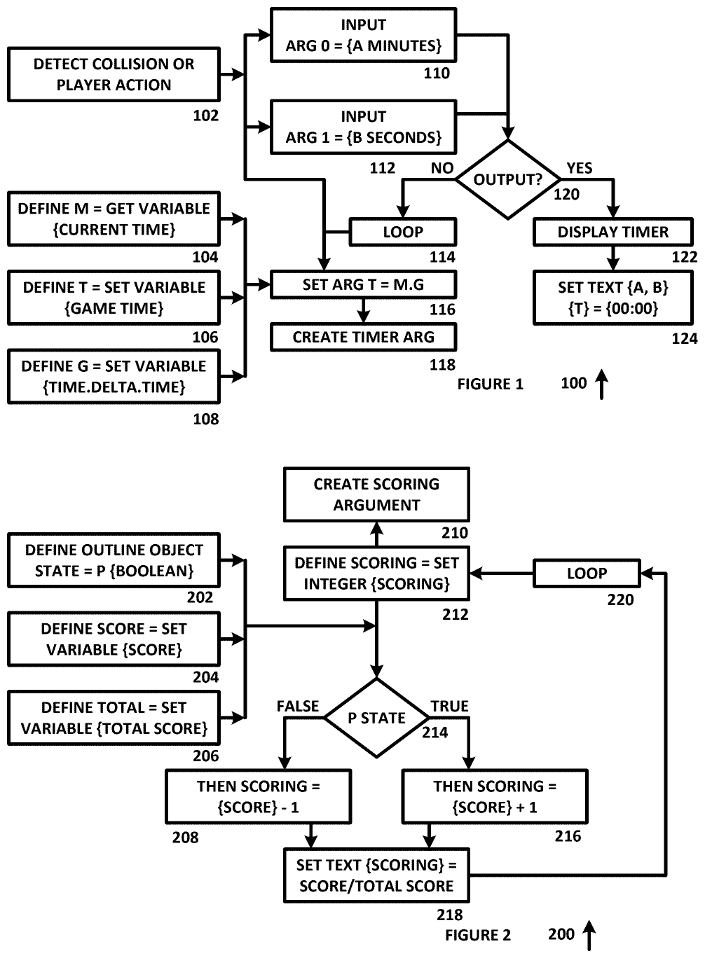

FIG. 1 is a diagram of an algorithm 100 for setting a timer in a gamified virtual construction lab, in accordance with an example embodiment of the present disclosure. Algorithm 100 can be implemented in hardware or a suitable combination of hardware and software.

Algorithm 100 begins at 102, where a collision or player action is detected. In one example embodiment, a collision detection system can be defined by one or more algorithms that are loaded into the working memory of a processor and that cause the processor, when executed, to receive game model data and to generate a virtual environment using the game model data. The collision detection system can include one or more algorithms to receive player movement data within the virtual environment and to detect a collision between the player or an object being manipulated by the player and the virtual environment components.

In addition, a game time variable M is set to zero at the game start, a script is started upon detection of a collision or player action and a variable T is displayed on a selected display, such as a dashboard, a screen, a user interface device such as a watch or in other suitable manners. In one example embodiment, a game timer system can be defined by one or more algorithms that are loaded into the working memory of a processor and that cause the processor, when executed, to track an elapsed time since the player started to attempt a gamer objective. In one example embodiment, a game objectives system can be defined by one or more algorithms that are loaded into the working memory of a processor and that cause the processor, when executed, to generate game objectives for the player and to associate the game objectives with objects and structures in the virtual environment. The algorithm then proceeds to 110, 112 and 116.

At 104, a variable M is defined, such as by using a get variable function with an argument of (current time). In one example embodiment, the variable M can be associated with an objective, a user level or other suitable factors. In one example embodiment, a variable definition system can be defined by one or more algorithms that are loaded into the working memory of a processor and that cause the processor, when executed, to define a variable. The algorithm then proceeds to 116.

At 106, a variable T is defined, such as by using a set variable function with an argument of (game time), the variable definition system or other suitable processes. In one example embodiment, the variable T can be associated with an objective, a user level, other attributes of the game objective system or other suitable factors. The algorithm then proceeds to 116.

At 108, a variable G is defined, such as by using a set variable function an argument of time. delta. time, the variable definition system or other suitable processes. In one example embodiment, the variable G can be associated with an objective, a user level, other attributes of the game objective system or other suitable factors. The algorithm then proceeds to 116.

At 110, an input argument 0 is set equal to A minutes. In one example embodiment, the variable A can be associated with an objective of the game objectives system, a user level or other suitable factors. The algorithm then proceeds to 120.

At 112, an input argument 1 is set equal to B seconds. In one example embodiment, the variable B can be associated with an objective of the game objectives system, a user level or other suitable factors. The algorithm then proceeds to 120.

At 116, set argument T=m·g or other suitable values. The algorithm then proceeds to 118.

At 118, a timer argument is created.

At 120, it is determined whether there is an output. If there is not output, the algorithm loops to 114, otherwise the algorithm proceeds to 122 where a timer is displayed. The algorithm then proceeds to 124.

At 124, text (a, b) and any other suitable text is set for display, and the timer is reset to T=00:00 or other suitable values.

In operation, algorithm 100 provides for setting a timer in a gamified virtual construction lab that allows activities and tasks to be timed. Although algorithm 100 is shown as a flow chart, a person of skill in the art will recognize that it can also or alternatively be implemented as a state diagram, a ladder diagram using an object-oriented programming paradigm, using a combination of such paradigms or in other suitable manners.

Scoring registration and reporting in the game can be based on a suitable type of action that is triggered by a specific routine. In one example embodiment, the actions can be a score registration, a score reporting or other suitable actions. For score registration (positive or negative) to take place, one or more of the example routines identified below can be completed within any single game frame, or other suitable routines can also or alternatively be used.

Outline game object destruction (positive score)—if a game object tagged ‘scoring’ is destroyed by a collision, then a score can be recorded for that player's action.

Outline game object instantiation (negative score)—if a game object tagged ‘scoring’ is instantiated after a player action, a negative score can be recorded for that player action.

For score reporting, a suitable number of displays can be provided to display the recorded scores throughout the game play experience and can be updated in every game frame. The two canvases include—
Menu Dashboard—scores can be displayed on the main game menu dashboard, where the player can return to and interact with any menu items.
Virtual Watch—scores can be displayed on the player's virtual watch, which can be accessed regardless of their world position.

FIG. 2 is a diagram of an algorithm 200 for setting a score in a gamified virtual construction lab, in accordance with an example embodiment of the present disclosure. Algorithm 200 can be implemented in hardware or a suitable combination of hardware and software. Algorithm 200 sets a default score of zero, creates conditions for setting a score and specifies what actions should start and stop.

Algorithm 200 begins at 202, where an outline object state is defined to be equal to a function of P (Boolean). In one example embodiment, the outline object state and function of P (Boolean) can be associated with an objective, a user level, other attributes of the game objective system or other suitable factors. The algorithm then proceeds to 214.

At 204, a variable score is defined to be equal to a set variable function of the score. In one example embodiment, the set variable function of the score can be associated with an objective, a user level, other attributes of the game objective system or other suitable factors. The algorithm then proceeds to 214.

At 206, a variable total is defined to be equal to a set variable function of the total score. In one example embodiment, the set variable function of the total score can be associated with an objective, a user level, other attributes of the game objective system or other suitable factors. The algorithm then proceeds to 214.

At 210, a scoring argument is created. In one example embodiment, the scoring argument can be associated with an objective, a user level, other attributes of the game objective system or other suitable factors.

At 212, a scoring variable is defined by setting it equal to a set integer function for (scoring). The algorithm then proceeds to 210.

At 214, it is determined whether a p state is true or false. In one example embodiment, the p state can be associated with an objective, a user level, other attributes of the game objective system or other suitable factors. If the p state is true, then the algorithm proceeds to 216, if the p state is false, then the algorithm proceeds to 208.

At 216, a scoring variable is set equal to score plus one. In one example embodiment, the score can be incremented by non-integer amounts or in other suitable manners. The algorithm then proceeds to 218.

At 208, a scoring variable is set equal to a score minus one. In one example embodiment, the score can be decremented by non-integer amounts or in other suitable manners. The algorithm then proceeds to 218.

At 218, a text for scoring is set equal to a score divided by a total score or other suitable value. The algorithm then proceeds to 220.

At 220, the algorithm loops to 212.

In operation, algorithm 200 provides for setting a score in a gamified virtual construction lab that allows activities and tasks to be scored. Although algorithm 200 is shown as a flow chart, a person of skill in the art will recognize that it can also or alternatively be implemented as a state diagram, a ladder diagram using an object-oriented programming paradigm, using a combination of such paradigms or in other suitable manners.

Level management in the game can be based on the logic for listening to scoring variables and responding accordingly. The level management logic can be designed to disable other modules, logics or scripts, activate game objects, and destroy game objects while listening to scoring variables which update at a frequency of approximately 75 times within a second.

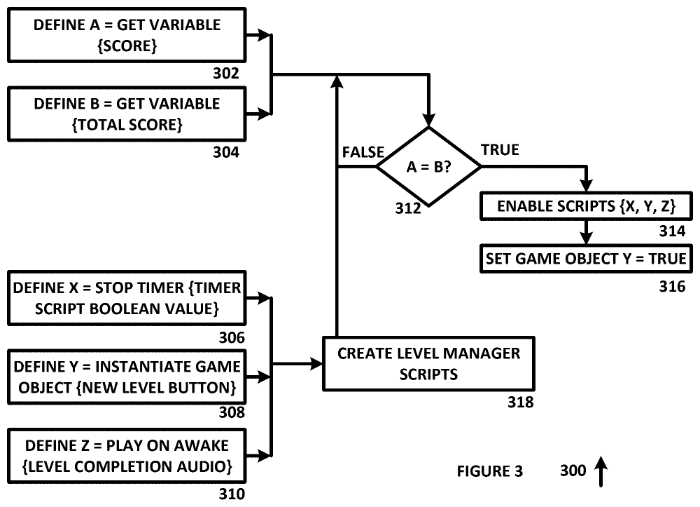

FIG. 3 is a diagram of an algorithm 300 for creating level manager scripts in a gamified virtual construction lab, in accordance with an example embodiment of the present disclosure. Algorithm 300 can be implemented in hardware or a suitable combination of hardware and software. Algorithm 300 creates the end result of the logic upon level completion and specifies what actions should start or stop.

At 302, a variable A is defined by setting it equal to a get variable function of a variable score. In one example embodiment, the variable A can be associated with an objective, a user level, other attributes of the game objective system or other suitable factors. The algorithm then proceeds to 312.

At 304, a variable B is defined by setting it equal to a get variable function of a variable total score. In one example embodiment, the variable B can be associated with an objective, a user level, other attributes of the game objective system or other suitable factors. The algorithm then proceeds to 312.

At 306, a variable X is defined by setting it equal to a stop time function of a timer script Boolean value. In one example embodiment, the variable X can be associated with an objective, a user level, other attributes of the game objective system or other suitable factors. The algorithm then proceeds to 318.

At 308, a variable Y is defined by setting it equal to an instantiate game object function of new level button. In one example embodiment, the variable Y can be associated with an objective, a user level, other attributes of the game objective system or other suitable factors. The algorithm then proceeds to 318.

At 310, a variable Z is defined by setting it equal to a play on awake function of a level completion audio value. In one example embodiment, the variable Z can be associated with an objective, a user level, other attributes of the game objective system or other suitable factors. The algorithm then proceeds to 318.

At 318, level manager scripts are created. In one example embodiment, the level manager scripts can be associated with an objective, a plurality of objectives, a user level, other attributes of the game objective system or other suitable factors. The algorithm then proceeds to 312.

At 312, it is determined whether variable A equals variable B. If not, the algorithm returns to 312 with updated inputs, otherwise, the algorithm proceeds to 314.

At 314, scripts are enabled with variables X, Y and Z. In one example embodiment, the variables X, Y and Z can be associated with an objective, a user level, other attributes of the game objective system or other suitable factors. The algorithm then proceeds to 316.

At 316, a game object Y is set to true. In one example embodiment, the game object can be associated with an objective, a user level, other attributes of the game objective system or other suitable factors.

In operation, algorithm 300 provides for creating level manager scripts in a gamified virtual construction lab. Although algorithm 300 is shown as a flow chart, a person of skill in the art will recognize that it can also or alternatively be implemented as a state diagram, a ladder diagram using an object-oriented programming paradigm, using a combination of such paradigms or in other suitable manners.

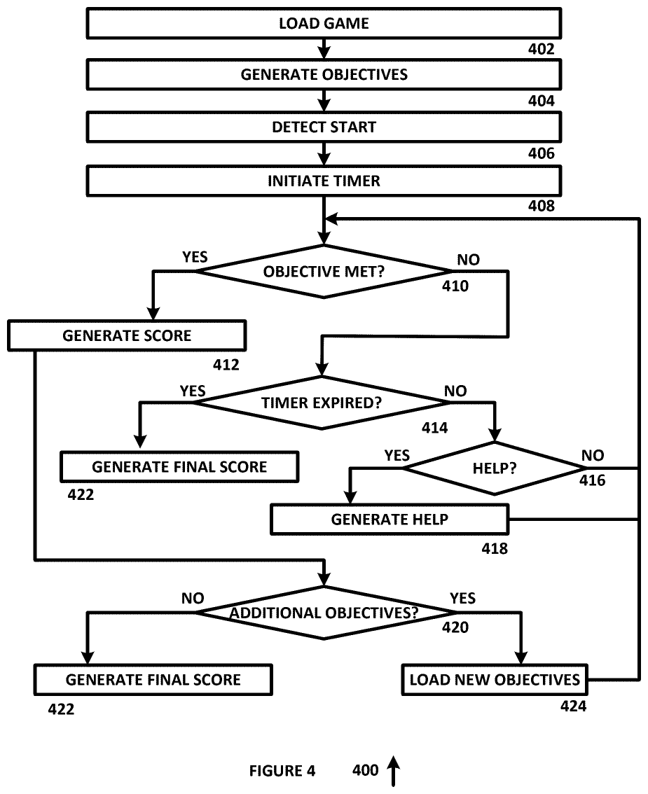

FIG. 4 is a diagram of an algorithm 400 for controlling user interaction in a gamified virtual construction lab, in accordance with an example embodiment of the present disclosure. Algorithm 400 can be implemented in hardware or a suitable combination of hardware and software. Algorithm 400 controls user interaction with objectives in a gamified virtual construction lab or other suitable training environments.

Algorithm 400 begins at 402 where game logic is loaded. In one example embodiment, the game logic can include a plurality of objectives, associated help, timer logic and other suitable logic that is associated with specific training objectives. In another example embodiment, the game logic can include audio cues, visual cues, haptic cues or other suitable cues. The game logic can include audio interference, visual interference, haptic interference or other suitable interference. The game logic can include audio help, visual help, haptic help or other suitable help. The game logic can be implemented by a game logic system that can be defined by one or more algorithms that are loaded into the working memory of a processor and that cause the processor, when executed, to receive game logic data and to generate game logic in a virtual environment using the game logic data, the game timer system, the game objectives system, the collision detection system or other suitable systems or processes. The algorithm then proceeds to 404.

At 404, one or more objectives are generated, such as using the game objectives system or other suitable systems or processes. In one example embodiment, a user can be advised of all objectives for a training session, but a user can also or alternatively be provided with objectives during performance of an objective, after completion of an objective or in other suitable manners. The algorithm then proceeds to 406.

At 406, a start is detected, such as using the game logic system or other suitable systems or processes. In one example embodiment, the start can be a user activation of a control, a user initiation of a movement or r other suitable actions. The algorithm then proceeds to 408.

At 408, a timer is initiated, such as using the timer system or other suitable systems or processes. In one example embodiment, the timer can be generated in a heads-up display, such as at a predetermined location like a wrist watch located above virtual hand or glove icons that track the location of the user's hands in space, such as using one or more tracking devices. The algorithm then proceeds to 410.

At 410, it is determined whether the objective has been met, such as using the game objectives system or other suitable systems or processes. In one example embodiment, an objective can include the proper placement of a virtual object, such as a brick, a window, a door, a wall frame or other suitable building components. Likewise, other suitable components can also or alternatively be used. If it is determined that an objective has been met, then the algorithm proceeds to 412. Otherwise, the algorithm proceeds to 414.

At 412, a score is generated, such as using the game objectives system or other suitable systems or processes. In one example embodiment, the score can be displayed at a predetermined location in the virtual environment, such as on a score board. Likewise, other suitable scoring mechanisms can also or alternatively be used. The algorithm then proceeds to 420.

At 414, it is determined whether a timer expired. In one example embodiment, the timer expiration can be continuously checked, and the learning algorithm can be terminated immediately upon expiration. In other embodiments, the timer can be modified as expiration approaches, such as to be augmented by an audible, visual or haptic indication, or other suitable processes can also or alternatively be used to alert a user of a timer expiration or impending expiration. If it is determined that a timer has expired, the algorithm proceeds to 422, otherwise the algorithm proceeds to 416.

At 416, it is determined whether any user help should be generated. User help can be generated as a function of user experience level, or game progression time, or as a function of other factors. If it is determined that the user should receive help, the algorithm proceeds to 418, otherwise the algorithm returns to 410.

At 418, help is generated. In one example embodiment, help can include audio cues or instructions (such as a recorded message), visual cues or instructions (such as an outline of where an object should be placed or text instructions), haptic cues (such as vibrations that increase when an object is moved farther away from where it should go) or other suitable help. The help can be generated as a function of game logic that has been loaded, as a function of user experience level, as a function of remaining time or in other suitable manners. The algorithm then proceeds to 420.

At 420, it is determined whether there are additional objectives, such as additional construction activities. If it is determined that additional objectives should be loaded, the algorithm proceeds to 424, otherwise the algorithm proceeds to 422.

At 422, a final score is generated. In one example embodiment, the final score can be displayed at a predetermined location in the virtual environment, such as on a score board. Likewise, other suitable scoring mechanisms can also or alternatively be used.

At 424, new objectives are loaded, such as additional construction activities, one or more interferences mechanisms (load noises, visual distractions, haptic interference) or other suitable. In one example embodiment, the objectives can be selected as a function of a current score, progress criteria or other suitable factors. The objectives can include one or more new objects, perspectives, interference mechanisms or other suitable game elements. The algorithm then returns to 410.

In operation, algorithm 400 provides controls for user interaction with objectives in a gamified virtual construction lab or other suitable training environments. Although algorithm 400 is shown as a flow chart, a person of skill in the art will recognize that it can also or alternatively be implemented as a state diagram, a ladder diagram using an object-oriented programming paradigm, using a combination of such paradigms or in other suitable manners.

The present disclosure has numerous practical applications in different environments. The VR construction lab can be used for construction assembly in architecture and construction learning VR applications. It can also be utilized where training is needed using a gamified and assembly approach. In one example embodiment, the present disclosure can be used for manufacturing and industrial training, to simulate intricate machinery operations and manufacturing processes for comprehensive industrial training. In another example embodiment, the present disclosure can be used for medical training, where students in training can practice surgeries, perform diagnostics and simulate patient interactions. Another example embodiment is emergency response training, where the systems and methods of the present disclosure can be used to train crisis management skills through realistic virtual emergency simulations. Aviation and aerospace training can also be provided to practice emergency procedures and enhance operational skills. Military training can be provided to enhance tactical decision-making, scenario response, and strategic skills. For architecture and design, the present disclosure can be used to train users for interactions with product mock-ups for design decision-making. For hospitality, virtual scenarios can be provided for hospitality professionals to enhance customer service and respond to situations promptly. For automotive and mechanical engineering, automotive assembly processes and vehicle maintenance procedures for technician training can be provided.

Assessment within the game can be based on level completion or other suitable factors. The VR lab game can reinforce a user's cognitive skills as they progress through the game levels.

Because the game provides increasing levels of difficulty, completion rates drop as game complexity increases. Scores can be reported to an instructor's dashboard on a platform application for progress reporting, and can include platform titles, profiles of instructors and students, the total number of times the courses have been completed and other suitable data. The reporting dashboard can be configured to provide real-time feedback to both students and instructors.

The present disclosure provides a comprehensive virtual reality game that enables users to develop skills needed in the construction industry or other suitable industries. It can help prepare workers for their job and provide them with a virtual space where they can hone their skills and develop expertise before stepping on a job site. The game is not only useful for workers but also for aspiring construction professionals or other professionals looking to gain the necessary experience and knowledge before joining the workforce. The present disclosure provides a holistic approach to learning applications using a gamified approach in a non-traditional VR environment. It enables users to embody a construction assembly role on job sites, with realistic visual and auditory feedback, or to experience other job environments. Gamification is one major differentiator and uses the level of progressing difficulty in assembly, combined with audio, visual, and haptic feedback with fine precision snapping upon grab release.

The present disclosure provides realism in terms of body scale simulation, object size and audio immersion in the environment. Increasing levels of difficulty make the VR present disclosure unique, as well as a visually stimulating and engaging scoring system that keeps users learning yet entertained.

The present disclosure can be easily deployed in a classroom to support predetermined teaching strategies. Users can conduct their learning experiences regardless of physical location, while instructors can monitor progress via an application dashboard. Specific techniques can be deployed in-game to augment the immersion, such as realistic background audio, realistic object physics, and sensory vibration of controllers. A large number of the components in the real world can thus be simulated in the VR game, even to the point of resulting in physical exhaustion during use.

### REFERENCES

Milovanovic, J., Moreau, G., Siret, D., & Miguet, F. (2017). Virtual and Augmented Reality in Architectural Design and Education An Immersive Multimodal Platform to Support Architectural Pedagogy. Paper presented at the Future Trajectories of Computation in Design, 17th International Conference, CAAD Futures, Istanbul, Turkey.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general-purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general-purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for providing a gamified virtual construction lab, comprising:
a game model system having one or more algorithms that are loaded into a working memory of a processor that cause the processor when executed to generate a virtual game environment;
an objectives system having one or more algorithms that are loaded into a working memory of a processor that cause the processor when executed to display one or more game objectives to a user in the virtual game environment;
a user movement system having one or more algorithms that are loaded into a working memory of a processor that cause the processor when executed to receive object selection data by a user of an object in the virtual environment, user movement data from one or more movement data sources, and user orientation data from one or more user orientation data sources, to determine whether the user movement data and the user orientation data results in a collision between the selected object and the virtual game environment and to generate collision data; and
a scoring system having one or more algorithms that are loaded into a working memory of a processor that cause the processor when executed to receive the collision data and the game objectives and to generate score data in response.

2. The system of claim 1 further including a timer system having one or more algorithms that are loaded into a working memory of a processor that cause the processor when executed to generate a timer display in the virtual game environment.

3. The system of claim 2 wherein the scoring system is configured to receive timer data from the timer system and to modify the score data in response to the timer data.

4. The system of claim 1 further comprising a level management system having one or more algorithms that are loaded into a working memory of a processor that cause the processor when executed to input data as a function of a scoring algorithm and to modify the score data as a function of level score.

5. The system of claim 1 wherein the user movement system is configured to receive the object data and to modify a view of the virtual game environment to simulate a restricted field of view of the virtual game environment as a function of the user orientation data and the virtual game environment.

6. The system of claim 1 wherein the user movement system is configured to receive the object data and to modify a view of the virtual game environment to simulate a collision of the object in the virtual game environment as a function of the user orientation data and the virtual game environment.

7. The system of claim 1 wherein the user movement system is configured to receive the object data and to modify a view of the virtual game environment to simulate placement of the object in the virtual game environment as a function of the user orientation data and the virtual game environment.

8. The system of claim 1 wherein the user movement system is configured to receive the object data and to modify a view of the virtual game environment to simulate placement of the object in the virtual game environment as a function of the user orientation data and the virtual game environment and the scoring system is configured to generate a score as a function of the placement of the object.

9. The system of claim 1 wherein the user movement system is configured to receive the object data and to modify a view of the virtual game environment to simulate placement of the object relative to a second object in the virtual game environment as a function of a first location of the object and a second location of the second object.

10. The system of claim 1 further comprising a detection system having one or more algorithms that are loaded into a working memory of a processor that cause the processor when executed to identify potential safety hazards in construction environments, and detect the positions of a user's body joints, compare the posture of the user with ergonomic standards, and determine whether the body movements are potentially harmful when lifting, bending, or carrying heavy loads.

11. A method for providing a gamified virtual construction lab, comprising:
loading one or more algorithms into a working memory of a processor that cause the processor when executed to perform the steps of:
generating a virtual game environment;
displaying one or more game objectives to a user in the virtual game environment;
receiving object selection by the user of an object in the virtual environment;
receiving user movement data from one or more movement data sources and user orientation data from one or more user orientation data sources;
determining whether the user movement data and the user orientation data results in a collision between the selected object and the virtual game environment;
generating collision data if the user movement data and the user orientation data results in the collision; and
generating score data in response to the collision data and the game objectives.

12. The method of claim 11 wherein the processor is further configured to generate a timer display in the virtual game environment.

13. The method of claim 11 wherein the processor is further configured to receive timer data and to modify the score data in response to the timer data.

14. The method of claim 11 wherein the processor is further configured to input data as a function of a scoring algorithm and to modify the score data as a function of level score.

15. The method of claim 11 wherein the processor is further configured to receive the object data and to modify a view of the virtual game environment to simulate a restricted field of view of the virtual game environment as a function of the user orientation data and the virtual game environment.

16. The method of claim 11 wherein the processor is further configured to receive the object data and to modify a view of the virtual game environment to simulate a collision of the object in the virtual game environment as a function of the user's spatial transformation, the object's spatial transformation and geometry data, and the virtual game environment.

17. The method of claim 11 wherein the processor is further configured to receive the object data and to modify a view of the virtual game environment to simulate placement of the object in the virtual game environment as a function of the the object's spatial transformation and geometry data and the virtual game environment.

18. The method of claim 11 wherein the processor is further configured to receive the object data and to modify a view of the virtual game environment to simulate placement of the object in the virtual game environment as a function of the user orientation data and the virtual game environment and to generate a score as a function of the placement of the object.

19. The method of claim 11 wherein the processor is further configured to receive the object data and to modify a view of the virtual game environment to simulate placement of the object relative to a second object in the virtual game environment as a function of a first location of the object and a second location of the second object.

20. The method of claim 11 wherein the processor is further configured to identify potential safety hazards in construction environments, and detect the positions of a user's body joints, compare the posture of the user with ergonomic standards, and determine whether the body movements are potentially harmful when lifting, bending, or carrying heavy loads.
